(19) United States
(12) Patent Application Publication
(10) Pub. No.: US 2019/0373906 A1
(43) Pub. Date: Dec. 12, 2019

(54) POST-HARVEST TREATMENT METHOD USING CLONOSTACHYS ROSEA

(71) Applicant: DANSTAR FERMENT AG, ZUG (CH)

(72) Inventors: Jean-Marc SANCHEZ, Daux (FR); Olivier COR, Saint Jean de Boiseau (FR); Bertrand DELAUNOIS, Toulouse (FR); Matthieu MOREL, Rochefort du Gard (FR); Selma ROGALSKA, Wilanow - Warsaw (PL)

(21) Appl. No.: 16/479,384

(22) PCT Filed: Jan. 18, 2018
(86) PCT No.: PCT/EP2018/051153

§ 371 Date: Jul. 19, 2019

(30) Foreign Application Priority Data
Jan. 19, 2017 (EP) 17152236.0

(51) Int. Cl. A23B 7/155; A23B 7/16

(52) U.S. Cl. CPC A23B 7/155; A23B 7/16

(57) ABSTRACT

The present disclosure relates to a new post-harvest treatment method which can be applied to harvested agricultural produce to reduce post-harvest spoilage or decay.

### TECHNOLOGICAL FIELD

The present disclosure relates to a post-harvest treatment method for the protection of harvested produce against plant pathogens, for the prevention or reduction of post-harvest microbial spoilage of harvested produce and/or for the control or the suppression of biological infestation in harvested produce.

### BACKGROUND

Plant pathogens constitute major constraints on crop yield. In addition to losses on growing in-field crops, some plant pathogens also carry over onto harvested commodities which can result in significant spoilage and decay of the produce during storage. Indeed, the majority of post-harvest pathogens infect the crop through wounds that occur during harvest or subsequent handling. Post-harvest losses during storage of crop produce are caused, for example, by water loss, leaf senescence, regrowth and rotting, the latter being caused by fungal and bacterial pathogens. It is estimated that about 25% of the world crop production is lost each year due to post-harvest diseases (as, for example, microbial spoilage), of which spoilage by fungi is by far the most important cause.

It is known that several synthetic chemical compounds can be used to prevent post-harvest damages of harvested produce. However, as known, the use of pesticides causes hazardous effects on humans and the environment. A strong regulation has been imposed, amongst other, on their post-harvest use. Since the use of chemical products has been reduced due to their harmful effect on human health and the environment, the production of fruits free from synthetic chemical residues is a driving cause to find alternative post-harvest treatments to decrease those post-harvest losses.

Biological control of post-harvest fungal pathogens by microbial antagonists such as Bacillus subtilis, Pseudomonas cepacia, Pseudomonas syringae, Pseudomonas fluorescens, Enterobacter aerogenes, Enterobacter cloacae and Debaryomyces hansenii has been described for a variety of stored vegetables and fruits including apple, apricot, cherry, citrus, grape, nectarine, peach, pear, pepper, plum, potato, strawberries and tomato (Wilson & Wisniewski, 1989). Therefore, the use of antagonistic microorganisms has been suggested as an effective, non-hazardous strategy to control, amongst other, major post-harvest decays of harvested produce.

There is thus a need to develop new and alternative biological post-harvest methods that will prevent, retard, inhibit or control the growth of plant pathogens on harvested produce to lengthen the post-harvest shelf-life of the stored harvested produce.

### BRIEF SUMMARY

The present disclosure relates to the use of the fungus Clonostachys rosea to extend or increase the post-harvest shelf-life of stored harvested produce. The present disclosure relates to a post-harvest treatment method which can be applied to harvested agricultural produce to reduce post-harvest spoilage or decay.

In a first aspect, the present disclosure concerns a post-harvest treatment method for protecting harvested produce against post-harvest decay caused by plant pathogen, for preventing or reducing post-harvest decay of harvested produce caused by plant pathogen or for controlling plant pathogen on harvested produce comprising applying to the harvested produce an isolated culture, fungal spore or formulation of C. rosea in an amount effective to protect the harvested produce against post-harvest decay caused by plant pathogen, to reduce post-harvest decay caused by plant pathogen or to extend post-harvest shelf-life of stored harvested produce relative to an untreated control. In an embodiment, the post-harvest method can further comprise, after applying to the harvested produce the isolated culture, fungal spore or formulation of C. rosea, storing said harvested produce at ambient conditions of temperature. In yet another embodiment, the post-harvest method can further comprise, after applying to the harvested produce the isolated culture, fungal spore or formulation of C. rosea, storing said harvested produce at a temperature less than 5° C. In still another embodiment, after storing the harvested produce at a temperature less than 5° C., it can be possible of storing said harvested produce at ambient conditions of temperature. In an embodiment, C. rosea is C. rosea f. catenulata and can be C. rosea f. catenulata strain J1446. In a further embodiment, the harvested produce is a fruit or a vegetable. In yet another embodiment, the harvested produce is a fruit. In an embodiment, the fruit is a stone fruit or a citrus fruit. The stone fruit can be peaches, nectarines, plums, apricots or cherries. The citrus fruit can be clementines, grapefruits, lemons, limes, mandarins, oranges or tangerines. In an embodiment, the post-harvest decay of harvested produce is caused by Penicillium spp., Alternaria spp., Rhizopus spp., Botrytis spp., Monilinia spp. or combinations thereof. In yet another embodiment, the post-harvest decay of harvested produce is caused by Penicillium spp. or Monilinia spp. In still another embodiment, the post-harvest decay of stone fruit is caused by Monilinia spp and the post-harvest decay of citrus fruit is caused by Penicillium spp. In an embodiment, the post-harvest decay of citrus fruit is caused by P. digitatum or P. italicum. In a further embodiment, the culture, fungal spore or formulation of C. rosea can be combined with an agriculturally acceptable carrier. In yet another embodiment, the culture of C. rosea can be applied to the harvested produce at a concentration of between about 10³ to 10¹² cfu/ml, about 10⁴ to 10¹¹ cfu/ml, about 10⁵ to 10¹⁰ cfu/ml or about 10⁶ to 10⁹ cfu/ml. In still another embodiment, the culture of C. rosea is in a dry formulation and applied to the harvested produce at a concentration of between about 10³ to 10¹² cfu/g, about 10⁴ to 10¹¹ cfu/g, about 10⁵ to 10¹⁰ cfu/g or about 10⁶ to 10⁹ cfu/g.

In a second aspect, the present disclosure concerns a post-harvest treatment method for protecting harvested produce against post-harvest decay caused by Monilinia spp., for preventing or reducing post-harvest decay of harvested produce caused by Monilinia spp. or for controlling Monilinia spp. on harvested produce comprising applying to the harvested produce an isolated culture, fungal spore or formulation of C. rosea in an amount effective to protect the harvested produce against post-harvest decay caused by Monilinia spp., to reduce post-harvest decay caused by Monilinia spp. or to extend post-harvest shelf-life of stored harvested produce relative to an untreated control. In an embodiment, the post-harvest method can further comprise, after applying to the harvested produce the isolated culture, fungal spore or formulation of C. rosea, storing said harvested produce at ambient conditions of temperature. In yet another embodiment, the post-harvest method can further comprise, after applying to the harvested produce the isolated culture, fungal spore or formulation of C. rosea, storing said fruit at a temperature less than 5° C. In still another embodiment, after storing the harvested produce at a temperature less than 5° C., it can be possible of storing said harvested produce at ambient conditions of temperature. In an embodiment, C. rosea is C. rosea f. catenulata and can be C. rosea f. catenulata strain J1446. In a further embodiment, the harvested produce is a fruit or a vegetable. In yet another embodiment, the harvested produce is a fruit. In an embodiment, the fruit is a stone fruit and can be peaches, nectarines, plums, apricots or cherries. In a further embodiment, the culture, fungal spore or formulation of C. rosea can be combined with an agriculturally acceptable carrier. In yet another embodiment, the culture of C. rosea can be applied to the harvested produce at a concentration of between about 10³ to 10¹² cfu/ml, about 10⁴ to 10¹¹ cfu/ml, about 10⁵ to 10¹⁰ cfu/ml or about 10⁶ to 10⁹ cfu/ml. In still another embodiment, the culture of C. rosea is in a dry formulation and applied to the harvested produce at a concentration of between about 10³ to 10¹² cfu/g, about 10⁴ to 10¹¹ cfu/g, about 10⁵ to 10¹⁰ cfu/g or about 10⁶ to 10⁹ cfu/g.

In a third aspect, the present disclosure concerns a post-harvest treatment method for protecting harvested produce against post-harvest decay caused by Penicillium spp., for preventing or reducing post-harvest decay of harvested produce caused by Penicillium spp. or for controlling Penicillium spp. on harvested produce comprising applying to the harvested produce an isolated culture, fungal spore or formulation of C. rosea f. catenulata in an amount effective to protect the harvested produce against post-harvest decay caused by Penicillium spp., to reduce post-harvest decay caused by Penicillium spp. or to extend post-harvest shelf-life of stored harvested produce relative to an untreated control. In an embodiment, the post-harvest method can further comprise, after applying to the harvested produce the isolated culture, fungal spore or formulation of C. rosea, storing said harvested produce at ambient conditions of temperature. In yet another embodiment, the post-harvest method can further comprise, after applying to the harvested produce the isolated culture, fungal spore or formulation of C. rosea, storing said fruit at a temperature less than 5° C. In still another embodiment, after storing the harvested produce at a temperature less than 5° C., it can be possible of storing said harvested produce at ambient conditions of temperature. In an embodiment, C. rosea is C. rosea f. catenulata and can be C. rosea f. catenulata strain J1446. In a further embodiment, the harvested produce is a fruit or a vegetable. In yet another embodiment, the harvested produce is a fruit. In still another embodiment, the fruit is a citrus fruit and can be clementines, grapefruits, lemons, limes, mandarins, oranges or tangerines. In a further embodiment, the culture, fungal spore or formulation of C. rosea can be combined with an agriculturally acceptable carrier. In yet another embodiment, the culture of C. rosea can be applied to the harvested produce at a concentration of between about 10³ to 10¹² cfu/ml, about 10⁴ to 10¹¹ cfu/ml, about 10⁵ to 10¹⁰ cfu/ml or about 10⁶ to 10⁹ cfu/ml. In still another embodiment, the culture of C. rosea is in a dry formulation and applied to the harvested produce at a concentration of between about 10³ to 10¹² cfu/g, about 10⁴ to 10¹¹ cfu/g, about 10⁵ to 10¹⁰ cfu/g or about 10⁶ to 10⁹ cfu/g.

In a fourth aspect, the present disclosure provides the use of an isolated culture, fungal spore or formulation of C. rosea in an amount effective for protecting harvested produce against post-harvest decay caused by plant pathogen, for reducing post-harvest decay caused by plant pathogen or for extending the post-harvest shelf-life of stored harvested produce relative to an untreated control. In an embodiment, C. rosea is C. rosea f. catenulata and can be C. rosea f. catenulata strain J1446. In a further embodiment, the harvested produce is a fruit or a vegetable. In yet another embodiment, the harvested produce is a fruit. In an embodiment, the fruit is a stone fruit or a citrus fruit. The stone fruit can be peaches, nectarines, plums, apricots or cherries. The citrus fruit can be clementines, grapefruits, lemons, limes, mandarins, oranges or tangerines. In an embodiment, the post-harvest decay of harvested produce is caused by Penicillium spp., Alternaria spp., Rhizopus spp., Botrytis spp., Monilinia spp. or combinations thereof. In yet another embodiment, the post-harvest decay of harvested produce is caused by Penicillium spp. or Monilinia spp. In still another embodiment, the post-harvest decay of stone fruit is caused by Monilinia spp. and the post-harvest decay of citrus fruit is caused by Penicillium spp. In an embodiment, the post-harvest decay of citrus fruit is caused by P. digitatum or P. italicum. In a further embodiment, the culture, fungal spore or formulation of C. rosea can be combined with an agriculturally acceptable carrier. In yet another embodiment, the culture of C. rosea can be applied to the harvested produce at a concentration of between about 10³ to 10¹² cfu/ml, about 10⁴ to 10¹¹ cfu/ml, about 10⁵ to 10¹⁰ cfu/ml or about 10⁶ to 10⁹ cfu/ml. In still another embodiment, the culture of C. rosea is in a dry formulation and applied to the harvested produce at a concentration of between about 10³ to 10¹² cfu/g, about 10⁴ to 10¹¹ cfu/g, about 10⁵ to 10¹⁰ cfu/g or about 10⁶ to 10⁹ cfu/g.

In an embodiment, the present disclosure provides a method for protecting fruits against post-harvest decay caused by Monilinia spp. comprising applying to the fruits an isolated culture, fungal spore or formulation of C. rosea. In a further embodiment, the present disclosure provides a method for reducing post-harvest spoilage or decay of fruits caused by Monilinia spp. comprising applying to the fruits an isolated culture, fungal spore or formulation of C. rosea. In still another embodiment, the present disclosure provides a method for extending post-harvest shelf-life of fruits infected by Monilinia spp. comprising applying to the fruits an isolated culture, fungal spore or formulation of C. rosea. In a further embodiment, the fruit is a stone fruit and can be peaches, nectarines, plums, apricots or cherries. In an embodiment, C. rosea is C. rosea f. catenulata and can be C. rosea f. catenulata strain J1446.

In an embodiment, the present disclosure provides a method for protecting fruits against post-harvest decay caused by Penicllium spp. comprising applying to the fruits an isolated culture, fungal spore or formulation of C. rosea. In a further embodiment, the present disclosure provides a method for reducing post-harvest spoilage or decay of fruits caused by Penicllium spp. comprising applying to the fruits an isolated culture, fungal spore or formulation of C. rosea. In still another embodiment, the present disclosure provides a method for extending post-harvest shelf-life of fruits infected by Penicllium spp. comprising applying to the fruits an isolated culture, fungal spore or formulation of C. rosea. In a further embodiment, the fruit is a citrus fruit and can be clementines, grapefruits, lemons, limes, mandarins, oranges or tangerines. In an embodiment, C. rosea is C. rosea f. catenulata and can be C. rosea f. catenulata strain J1446. In an embodiment, Penicllium spp. can be P. digitatum and P. italicum.

### BRIEF DESCRIPTION OF THE DRAWINGS

Having thus generally described the nature of the invention, reference will now be made to the accompanying drawings, showing by way of illustration, a preferred embodiment thereof, and in which:

FIG. 1 illustrates the percentage of decayed peaches cultivar ‘Sandine’ during post-harvest storage and compares peaches treated with C. rosea f. catenulata with controls.

FIG. 2 illustrates the percentage of decayed peaches cultivar ‘Western Red’ during post-harvest storage and compares peaches treated with C. rosea f. catenulata with controls.

FIG. 3 illustrates the distribution of the genera of fungi responsible for the spoilage of peaches cultivar ‘Sandine’ harvested for the assays and before the application of the post-harvest treatments (water, J1446 and non-treated control).

FIG. 4 illustrates the distribution of the genera of fungi responsible for the spoilage of peaches cultivar ‘Western Red’ harvested for the assays and before the application of the post-harvest treatments (water, J1446 and non-treated control).

FIG. 5 illustrates the effect of different post-harvest treatment methods on the cumulative percentage of rotten nectarines during storage at 20-22° C. (without refrigeration storage after post-harvest treatments).

FIG. 6 illustrates the effect of different post-harvest treatment methods on the cumulative percentage of rotten nectarines during storage at 20-22° C. (with refrigeration storage after post-harvest treatments).

FIG. 7 illustrates the distribution of the genera of fungi responsible for the spoilage of nectarines harvested for the assays and before the application of the post-harvest treatments (M1 to M7).

FIG. 8 illustrates the effect of different post-harvest treatment methods on the cumulative percentage of rotten plums (without refrigeration storage after post-harvest treatments).

FIG. 9 illustrates the effect of different post-harvest treatment methods on the cumulative percentage of rotten plums (with refrigeration storage after post-harvest treatments).

FIG. 10 illustrates the percentage of inoculated wound sites with positive disease symptoms caused by P. digitatum.

FIG. 11 illustrates the percentage of inoculated wound sites with positive disease symptoms caused by P. italicum.

### DETAILED DESCRIPTION

The present disclosure provides a post-harvest treatment method for protecting harvested produce against plant pathogens comprising applying to the harvested produce an effective amount of a culture of Clonostachys rosea. C. rosea is a wide-spread, soil-borne fungal saprophyte. This fungus is known as a biological control agent against various soil-borne and foliar plant pathogens. It has been discovered that the fungus C. rosea has the property of preventing, retarding or inhibiting growth of plant pathogens on harvested produce and may consequently be used for post-harvest treatment of harvested plant. It has been demonstrated that C. rosea can be applied to agricultural produce to reduce post-harvest spoilage, decay or rotting via a competitive inhibition with phytopathogens. The present disclosure relates also to a use of the fungus C. rosea to extend or increase the post-harvest shelf-life of stored harvested produce.

An “effective amount”, as used herein, is an amount sufficient to effect beneficial or desired results.

In the context of the present disclosure, the biological control agent is the fungus C. rosea. Any species or strains of C. rosea may be used in the disclosed methods. Indeed, many isolates of C. rosea are highly efficient antagonists against several plant pathogenic fungi. The biological control agent C. rosea is an antagonistic fungal plant pathogen that is widely present in soil and can produce a series of antibacterial metabolites. In an embodiment, C. rosea is C. rosea f. catenulata. In a further embodiment, the fungus is C. rosea f. catenulata J1446. This strain has been deposited on 19 May 1994 according to the Budapest Treaty to the DSM depositary by the accession number DSM 9212. C. rosea f. catenulata J1446 is commercially available under the trademark PRESTOP® (Lallemand (Verdera, Finland)).

The fungus C. rosea of the present disclosure is formulated as a liquid suspension or in a dry powder according to any suitable methods known in the art. The biologically pure culture, suspension or formulation (comprising, but not limited to, conidia, mycelium fragments and spores) is applied to the harvested produce at a concentration of between about 10³ to 10¹² cfu (“colony forming unit”)/ml, about 10⁴ to 10¹¹ cfu/ml, about 10⁵ to 10¹⁰ cfu/ml or about 10⁶ to 10⁹ cfu/ml. C. rosea is applied to the harvested produce in a liquid suspension at a concentration of about 1×10⁴, about 1×10⁵, about 1×10⁶, about 1×10⁷, about 1×10⁸, about 1×10⁹, about 1×10¹⁰, about 1×10¹¹, about 1×10¹², about 1×10¹³ cfu/ml or greater than 1×10¹³ cfu/ml. C. rosea can also be applied to the harvested produce in a dry formulation (comprising, but not limited to, conidia, mycelium fragments and spores) at a concentration of between about 10³ to 10¹² cfu/g, about 10⁴ to 10¹¹ cfu/g, about 10⁵ to 10¹⁰ cfu/g or between 10⁶ to 10⁹ cfu/g. C. rosea can also be applied to the harvested produce in a dry formulation at a concentration of about 1×10⁴, about 1×10⁵, about 1×10⁶, about 1×10⁷, about 1×10⁸, about 1×10⁹, about 1×10¹⁰, about 1×10¹¹, about 1×10¹², about 1×10¹³ cfu/ml or greater than 1×10¹³ cfu/g. The optimal amount can vary depending upon crop species and plant pathogens and can be readily determined by those skilled in the art.

The fungal culture, suspension or formulation according to the present disclosure can be applied to harvested produce by contacting the harvested produce by any means known to the artisan skilled in the art. The term “contacting” as used herein means causing the harvested produce to come into proximity with an exogenous liquid or solid (such as a powder) form of a composition according to the disclosure. Examples of such methods include, but are not limited to dipping, immersing, spraying, misting, fogging, coating, dusting or soaking application methods. The application forms and methods depend entirely on the intended purposes in order to ensure the finest and uniform distribution of the biological control agent onto the harvested produce. Aqueous application forms can be prepared from emulsion concentrates, pastes or wettable powders by adding water. It is also possible to prepare concentrates composed of the biological control agent, wetter, tackifier, dispersant or emulsifier and, if appropriate, solvent or oil, and such concentrates are suitable for dilution with water. The fungal culture, suspension or formulation according to the present disclosure is applied to the harvested produce as a single dose exposure or in multiple doses or exposures at different times.

The fungal antagonist of the present disclosure is effective for harvested produce, as for example for fruits, stored at ambient conditions of temperature (±20° C.). The fungal antagonist of the present disclosure of the present description can also be used for harvested produce stored at temperatures less than 5° C. The fungus can theoretically be applied at any time during the harvest, grading, shipping process, or during the early stages of storage. Of course, the harvested fruits or vegetables are more susceptible to infection any time a wound occurs and a fungal disease agent is present. Therefore, the longer the delay between the wounding and the treatment with the fungal composition, the greater the chance the pathogen will successfully infect the harvested produce.

The fungal culture, suspension or formulation can be applied, after harvesting, onto the surface of the harvested produce in combination with any known agriculturally-acceptable adjuvant, carrier or binder formulation. Agriculturally-acceptable adjuvants, carriers or binders are commercially available and must be safe for human consumption. The microorganisms may also be applied in suspension with liquid culture medium. The compositions may also include conventional additives such as surfactants and wetting agents to enhance the effectiveness of the organisms. As an integrated approach, the harvested produce can also be treated with other antifungal and/or antimicrobial compositions, commonly known to the person skilled in the art, either prior or after treatment of the harvested produce with the post-harvest treatment of the present disclosure.

The post-harvest treatment according to the present disclosure is important in the control of fungi on various harvested produce, such as fruits (such as, but not limited to, stone fruits or soft fruits or citrus fruits), vegetables, flowers or nuts. Indeed, as used herein, the term “harvested produce” refers to all harvested product, crop, such as fruits, vegetables, nuts, cut flowers, etc. derived from a plant. According to a further embodiment, the post-harvest treatment of the present disclosure is particularly important in the control of plant pathogens on various harvested produce such as, but not limited, apple, apricot, banana, blueberry, cantaloupe, carrot, clementine, cherry, cranberry, cucumber, endive, garlic, grapefruit, kaki, kiwi, grape, lemon, lime, lettuce, mandarin, mango, melon, mushroom, nashi, nectarine, onion, orange, papaya, peach, pear, pepper, pineapple, plum, prune, pumpkin, raspberry, strawberry, tangerine, tomato or watermelon. In one particular embodiment, the harvested produce is a stone fruit. In a further embodiment, the stone fruit is a peach, nectarine, plum, apricot or cherry. In some embodiments, the harvested produce is a citrus fruit and can be, for example, a clementine, grapefruit, lemon, lime, mandarin, orange or tangerine.

The post-harvest treatment method of the present disclosure is suitable for controlling plant pathogens. The post-harvest treatment method of the present disclosure is suitable for controlling fungal plant pathogens. In a further embodiment, the post-harvest treatment method of the present disclosure is suitable for biologically controlling or reducing post-harvest spoilage or post-harvest rotting caused by the following fungi: Colletotrichum spp., Fusarium spp., Alternaria spp., Botrytis spp., Monilinia spp. (Monilia spp.), Lasiodiplodia spp., Phomopsis spp., Botryosphaeria spp., Verticillium spp., Geotrichum spp., Phytophthora spp., Septoria spp., Mucor spp., Venturia spp., Rhizopus spp., Glomerella spp., Sclerotinia spp., Ceratocystis spp., Penicillium spp., Gloeosporium spp., Phlyctaena spp., Cylindrocarpon spp., Stemphyllium spp., Phacydiopycnis spp., Thielaviopsis spp., Aspergillus spp., Nectria spp., or combinations thereof. In one particular embodiment, the post-harvest treatment method of the present disclosure is suitable for controlling, retarding or reducing post-harvest spoilage caused by Penicllium spp., Alternaria spp., Rhizopus spp., Botrytis spp., Monilinia spp. or combinations thereof. In a further embodiment, the post-harvest treatment method of the present disclosure is suitable for controlling, retarding or reducing post-harvest spoilage or post-harvest rotting caused by Monilinia spp., more particularly caused by M. fructicola or M. taxa. More particularly, the post-harvest treatment method of the present disclosure can be used for protecting stone fruits against decay caused by Monilinia spp. as, for example, M. fructicola or M. taxa. The post-harvest treatment method of the present disclosure can also be used for controlling, retarding or reducing post-harvest spoilage caused by Penicllium spp. as for example, P. digitatum and P. italicum. In an embodiment, post-harvest treatment method of the present disclosure can be used, for example, for protecting citrus fruits against decay caused by P. italicum or P. digitatum.

The following examples serve to further describe and define the invention, and are not intended to limit the invention in any way.

### EXAMPLES

### Example 1: Efficacy of C. Rosea F. Catenulata Against Post-Harvest Diseases on Peaches

The objective of this study was to evaluate the effect of C. rosea f. catenulata for the management of post-harvest diseases on peaches, for preventing post-harvest decay and for reducing post-harvest losses of harvested peaches.

Fruits:

Peaches (‘Sandine’ and ‘Western Red’) were picked at firm ripe stage from a commercial orchard (using Integrated Fruit Production (IFP)) and store at 4° C. for 2 days or less.

Antagonist/Biocontrol Agent:

PDA (potato dextrose agar) in Petri dishes was inoculated with spores of C. rosea f. catenulata J1446 by placing a droplet of spore suspension containing about 10⁶ to 10⁷ cfu/ml onto the medium in each dish and spreading the droplet over the agar surface with a cell spreader. The dispersed spores initiated numerous colonies which sporulated heavily at 25° C. and the spores were normally collected after 8 days.

Fruit Inoculation:

The peaches were disposed on trays (22 peaches per tray). There were 4 replicates of 44 peaches per treatment and per variety, with one replicate of each treatment per tray. Non-treated fruits (i.e. produced fruits via Integrated Fruit Production) and fruits treated with water were used as negative controls.

For the post-harvest treatments, the fruits were sprayed to runoff (15 ml per tray) on both sides with a C. rosea f. catenulata J1446 suspension at a concentration of about 10⁷ cfu/ml. The peaches were air-dried and incubated at 22° C. Percent fruit infection was measured every 48 hours for 30 days.

Statistical Analysis:

Data were statistically analyzed using StetBox Pro. Analysis of variance was performed on arcsin square-root transformed data by the general linear models procedure. Mean separations were performed using the Student Newmann and Keuls test.

Results and Conclusion:

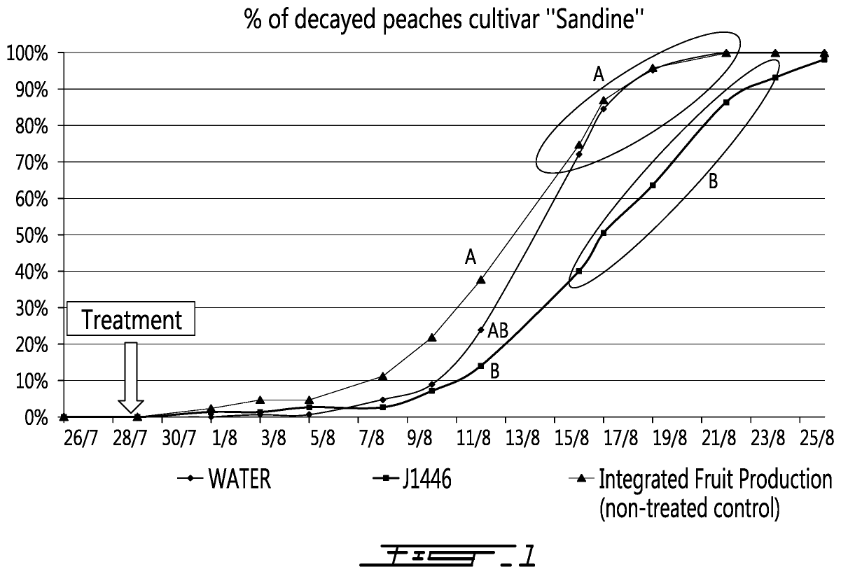

The results, as shown in FIG. 1, clearly demonstrated that the percentage of decayed harvested peaches ‘Sandine’ was significantly reduced when the harvested peaches were inoculated with C. rosea f. catenulata J1446 as compared to the controls.

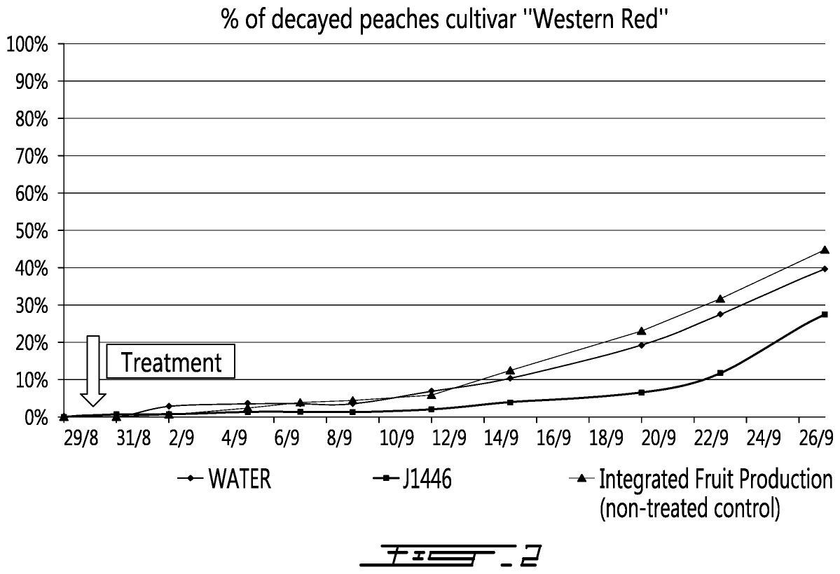

Results shown in FIG. 2 represent the decay incidence on harvested peaches cultivar ‘Western Red’ and indicate that this peach cultivar was less susceptible to post-harvest decay than the ‘Sandine’ cultivar. Although the post-harvest treatment with C. rosea f. catenulata J1446 retarded decay symptoms, the fungus treatment did not significantly reduce decay when compared with the controls.

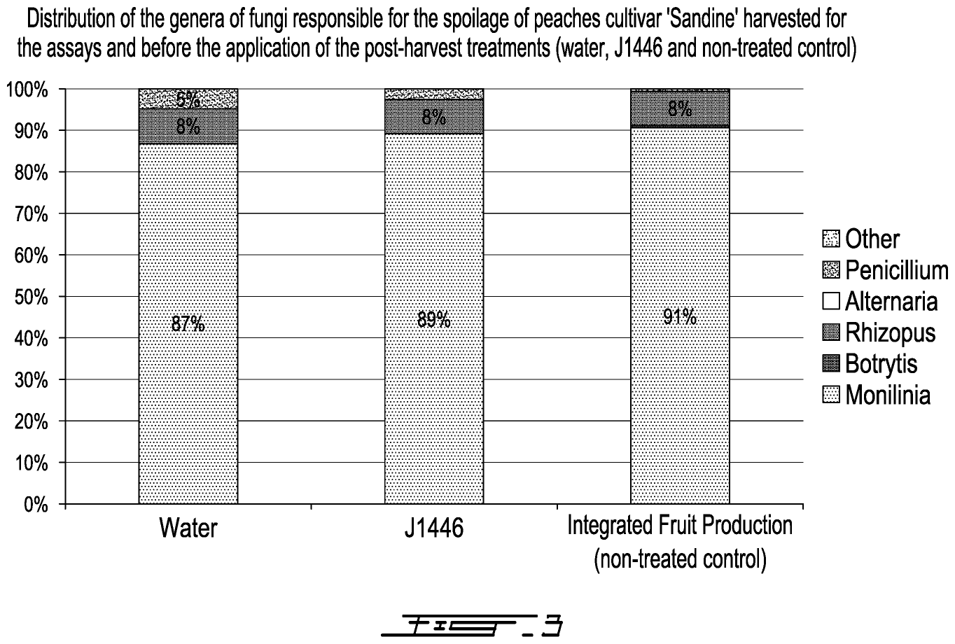

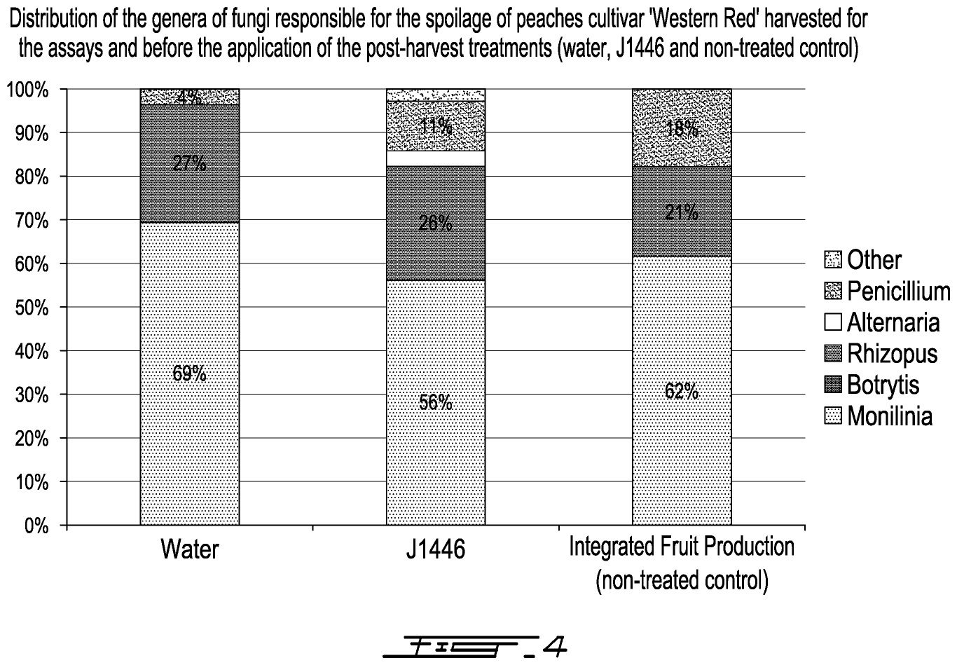

After analysis and as shown in FIGS. 3 and 4, it was demonstrated that spoilage on the peaches of both cultivars, before the post-harvest treatments, was caused by the following fungi: Monilinia spp., Rhizopus spp., Penicllium spp., Alternaria spp. and Botrytis spp. At the moment the post-harvest treatments were performed, Monilinia spp. was found to be associated as the predominant fungus with the rotten fruits.

Based on these results, it has been demonstrated that C. rosea f. catenulata J1446 can reduce the incidence and rate of development of Monilinia spp. infection in peaches.

In summary, as measured by their physical and sensory attributes, the use of C. rosea f. catenulata J1446 as a post-harvest treatment method preserved the quality of the peaches cultivars ‘Sandine’ and ‘Westernred’ during storage. These results demonstrated, amongst other, that C. rosea f. catenulata is a useful alternative for controlling pathogenic fungi, protecting harvested produce against storage diseases caused by plant pathogens, maintaining the post-harvest quality of peaches and extending the post-harvest shelf-life of the stored harvested produce.

### Example 2: Biological Control of Post-Harvest Fungal Rots of Nectarines Using C. Rosea F. Catenulata

The aim of this study was to investigate the effect of various post-harvest treatment methods (two different formulations of the biocontrol agent, with or without refrigeration storage after the post-harvest treatment) on the post-harvest quality of nectarines during storage conditions.

Fruits:

Nectarines (Variety: Nectatop; Year of planting: 2011; Distance between plantings and density: 6×3 m, i.e. 556 trees/ha) were picked at firm ripe stage, measured, selected (same size, same level of maturity, lack of damage) and boxed up with 260 to 280 fruits per tray. They were stored at 2-4° C. for 2 to 3 days.

Post-Harvest Treatments:

The nectarines were disposed on trays (60 nectarines per tray). There were four replicates of 60 nectarines per treatment. Non-treated fruits (i.e. produced fruits via Integrated Fruit Production) and fruits treated with water were used as negative controls. The trays were stored in an air-conditioned room at 20-22° C. for 15 to 21 days with or without a refrigerated storage at 2-4° C. for 5 to 8 days after the post-harvest treatment.

Nine different methods of treatment were tested and compared. They are defined in Table 1.

TABLE 1
Description of the tested methods of treatment

| | | | Post-harvest | | | | |
|---|---|---|---|---|---|---|---|
| | | | | | Post- | | |
| | | | | | harvest | | |
| | | | | | treatment | | |
| | Pre-harvest | | | | via a | | |
| | (during | | | Post- | nebulizing | | |
| | major | | | harvest | system (or | | |
| | work) | | | treatment | mist | Post- | |
| Methods of | R-21 | R-5 at | At | via | fogging | treatment | Storage |
| treatment | at 25 D | 10 D | harvesting | spraying | system) | storage | monitoring |
| M1 | Kruga | Signum | Fridge 2-4° C. | — | — | Refrigeration | Air- |
| TNT-Fridge | | | (2-3 | | | at 2-4° C. (5 to | conditioned |
| | | | days) | | | 8 days) | room at 20-22° C. |
| M2 | Kruga | Signum | | — | — | — | (15 to |
| TNT-Aircon | | | | | | | 21 days) |
| M3 | Kruga | Signum | | Prestop | — | Refrigeration | |
| Trai-WG | | | | WG ® | | at 2-4° C. (5-8 | |
| Fridge | | | | (0.20%) | | days) | |
| M4 | Kruga | Signum | | Prestop | — | — | |
| Trai-WG | | | | WG ® | | | |
| Aircon | | | | (0.20%) | | | |
| M5 | Kruga | Signum | | Prestop | — | — | |
| Trai-WP | | | | WP ® | | | |
| Aircon | | | | (2%) | | | |
| M6 | Kruga | Signum | | | Water | Refrigeration | |
| Water- | | | | | | at 2-4° C. (5-8 | |
| Fridge | | | | | | days) | |
| M7 | Kruga | Signum | | | Water | — | |
| Water- | | | | | | | |
| Aircon | | | | | | | |
| M8 | Kruga | Signum | | | Prestop | Refrigeration | |
| Nebu- | | | | | WG ® | at 2-4° C. (5-8 | |
| Fridge-WG | | | | | 1.4 g/m3 | days) | |
| | | | | | fridge | | |
| | | | | | (14 g in 2 l | | |
| | | | | | water) | | |
| M9 | Kruga | Signum | | | Prestop | — | |
| Nebu- | | | | | WG ® | | |
| Aircon-WG | | | | | 1.4 g/m3 | | |
| | | | | | fridge | | |
| | | | | | (14 g in 2 l | | |
| | | | | | water) | | |

The types of methods of treatment used in the study are described as follows:
Pre-harvest treatments in the orchard were performed on the whole plot with a flow rate of 750 l/ha. The products used were: Kruga (3 l/ha) and Signum (0.75 kg/ha). The applications of the pre-harvest treatments were performed on July 7 and 21, 2017 under good conditions. They were deliberately restricted to two interventions in order to promote serious pressure in terms of storage diseases.
Post-harvest application via hand-spraying for methods of treatment M3, M4 and M5 was performed according to the methodology described below.
Post-harvest application via the use of a nebulizer (or fogger or mister) for methods of treatment M6 to M9 according was performed according to the methodology described below.

For the post-harvest treatments, two different formulations of Prestop® (Lallemand) were tested. Prestop WP® and Prestop WG® contain C. rosea f. catenulata J1446. Prestop WG® (1×10⁹ cfu/g) is ten times more concentrated that Prestop WP® (1×10⁸ cfu/g).

A stock solution for each treatment was prepared using sterile distilled water with C. rosea f. catenulata J1446 and amounts of suspension were calculated to be applied at the equivalent of 2 g/I and 20 g/I for Prestop WG® and Prestop WP®, respectively. For methods of treatment M3, M4 and M5, the suspension was applied using a spray bottle pump. Eight sprays were applied onto one face of a tray for a total of 7.5 ml. For methods of treatment M6 to M9, the suspension was applied using a nebulizer (Atomist 1037, Hyprodis). The fruits were air-dried.

Following the inoculation step, the fruits treated with the methods of treatment M1, M3, M6 and M8 were submitted to a refrigerated storage at 2-4° C. for 5 to 8 days before the transfer in an air-conditioned room at 20-22° C. for 15 to 21 days. The fruits treated with the methods of treatment M2, M4, M5, M7 and M9 were directly stored in an air-conditioned room at 20-22° C. for 15 to 21 days without prior refrigerated storage.

Percent fruit infection along with the identification of the pathogens was measured every 48 hours for a minimum of 15 to 21 days.

Weather Conditions:

The climatic data have been routinely acquired by a CIMEL station. They were collected throughout the duration of the trial.

The trial took place in the orchard between 7 July and 7 Aug. 2017, the date on which the second harvest started and the fruits were placed in storage. This period was particularly warm and generally dry.

Statistical Analyses:

Data were statistically analyzed using StatBox Pro. Analysis of variance was performed on arcsin square-root transformed data by the general linear models procedure. Mean separations were performed using the Student Newmann and Keuls test.

Results and Conclusion:

Harvesting was performed five times. The yield from the plot was very high (59.6 T/ha), with a predominant size of A. The fruits destined for post-harvesting treatment and monitoring were picked during the second harvesting.

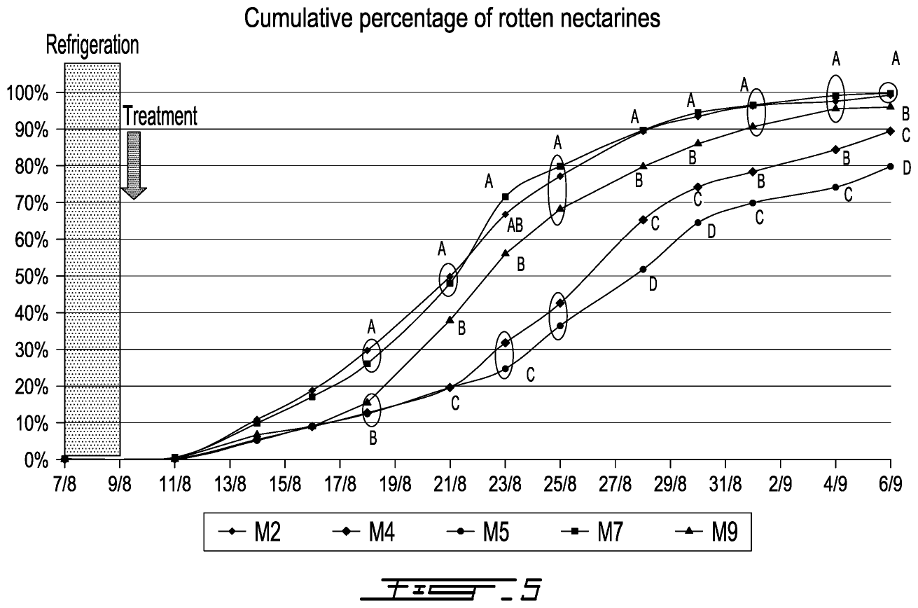

The methods of treatment M2, M4, M5, M7 and M9 were directly stored, after the post-harvest treatment, in an air-conditioned room at 20-22° C. for 15 to 21 days. As shown in FIG. 5, the appearance of rotten fruits in the control (M2) stored in the air-conditioned room was rapid, namely, 6 days after removal from the refrigerator and after the post-harvest treatment, 20% of the fruits were affected and after 12 days nearly 50% of the fruits were rotten. The pressure was sufficient to validate the trial.

As shown in FIG. 5, mist application (M9) or spray treatment (M4 and M5) of C. rosea f. catenulata J1446 to harvested nectarines stored at 20-22° C. significantly suppressed or reduced the incidence and development of rot in the fruits. The spray treatment (M4 and M5) showed a better effect of the biocontrol agent on the reduction of the rot rate compared to the treatment applied via the mist application (M9). It appears that the spray treatment (M4 and M5) ensured an effective and more uniform distribution of the biocontrol agent on the fruits.

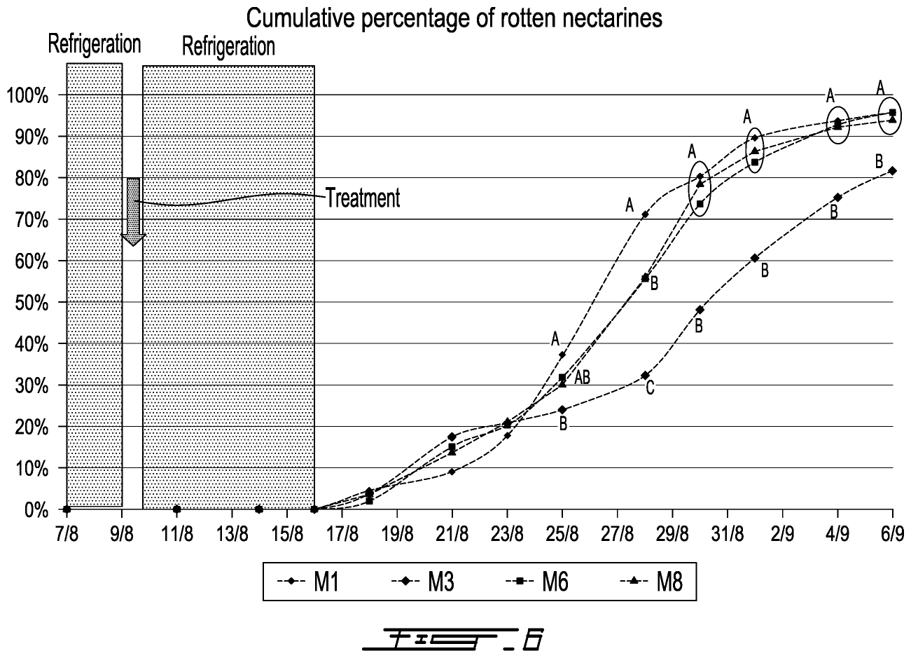

FIG. 6 shows the results of the cumulative percentage of rotten nectarines treated with methods of treatment M1, M3, M6 and M8. The fruits were refrigerated at 2-4° C. for 5 to 8 days after the post-harvest treatment and before the storage in the air-conditioned room at 20-22° C. for 15 to 21 days. The step of refrigeration after the post-harvest treatment and before the storage in the air-conditioned room allowed a greater multiplication of the pathogenic fungi due to temperature surges and condensation. Spray treatment (M3) of C. rosea f. catenulata J1446 to harvested nectarines significantly reduced incidence and rate of development of rotted fruits.

On a regular basis during the study, the fungi associated with the infected fruits were isolated and identified.

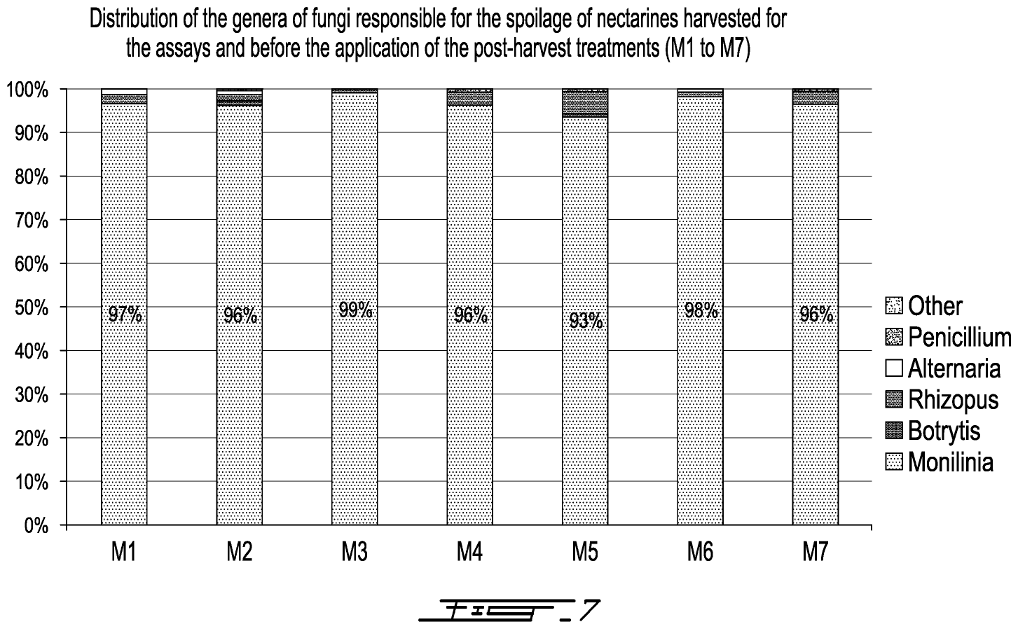

Results shown in FIG. 7 demonstrated that, on the harvest day of the nectarines, the pathogenic fungi isolated from the fruits were Monilinia spp., Rhizopus spp., Alternaria spp., Penicillium spp. and Botrytis spp. Monilinia spp. was found to be associated as the predominant fungus with the rotten fruits (before the post-harvest treatments were applied).

Based on these results, it has been demonstrated that C. rosea f. catenulata J1446 can reduce the incidence and rate of development of Monilinia spp. infection in harvested nectarines.

### Example 3: Biological Control of Post-Harvest Fungal Rots of Plums Using C. Rosea F. Catenulata

The aim of this study was to investigate the effect of various post-harvest treatment methods on the post-harvest quality of plums during storage conditions.

Fruits:

Plums (Variety: TC SUN; Year of planting: 2008; Distance between plantings and density: 4×1 m) were picked at firm ripe stage, measured, selected (same size, same level of maturity, lack of damage) and boxed. Monilinia spp. was found to be associated as the predominant fungus with the rotten fruits.

Post-Harvest Treatments:

The plums were disposed on trays (100 plums per tray). There were four replicates (trays) of 100 plums per method of treatment. Non-treated fruits (i.e. produced fruits via Integrated Fruit Production) were used as negative controls. The trays were stored at 0-0.5° C. for 48 hours.

Six different methods of treatment were tested and compared. They are defined in Table 3.

TABLE 3
Description of the tested methods of treatment

| | | Post-treatment |
|---|---|---|
| | Methods of treatment | storage condition |
| T1 | Untreated control | Air-conditioned room |
| T2 | Prestop WG ® (40 g/30 m³) - Post-harvest | at 19° C. for 15 to 30 |
| | treatment via nebulizing system (or mist | days |
| | fogging system) 48 hours after harvest | |
| T3 | Prestop WG ® 0.2% - Post-harvest | |
| | treatment via spraying 48 hours after | |
| | harvest | |
| T4 | Untreated control | |
| T5 | Prestop WG ® (40 g/30 m³) - Post-harvest | Refrigeration at |
| | treatment via nebulizing system (or mist | 0-0.5° C. for 4 to |
| | fogging system) 48 hours after harvest | 6 weeks followed |
| T6 | Prestop WG ® 0.2% - Post-harvest | by storage in |
| | treatment via spraying 48 hours after | air-conditioned room |
| | harvest | at 19° C. for 15 to |
| | | 30 days |

For the post-harvest treatments, Prestop WG® (Lallemand) which contains C. rosea f. catenulata J1446 was used.

A stock solution of Prestop WG® was prepared using sterile distilled water with C. rosea f. catenulata J1446 and amounts of suspension were calculated to be applied at the equivalent of 2 g/I. The suspension was applied using a spray bottle pump. Eight sprays were applied onto one face of a tray for a total of 7.5 ml. For treatments T4 to T6, the suspension was applied using a nebulizer (Atomist 1037, Hyprodis). The fruits were air-dried.

Following the inoculation step, the plums treated with the treatments method T4 to T6 were submitted to a refrigerated storage at 0-0.5° C. for 4 to 6 weeks before the transfer in an air-conditioned room at 19° C. until the end of the study. The fruits treated with the treatments method T1 to T3 were directly stored in an air-conditioned room at 19° C. until the end of the study.

Percent fruit infection along with the identification of the pathogens was measured every 48-72 hours for 5 to 30 days.

Statistical Analyses:

Data were statistically analyzed using StatBox Pro. Analysis of variance was performed on arcsin square-root transformed data by the general linear models procedure. Mean separations were performed using the Student Newmann and Keuls test.

Results and Conclusion:

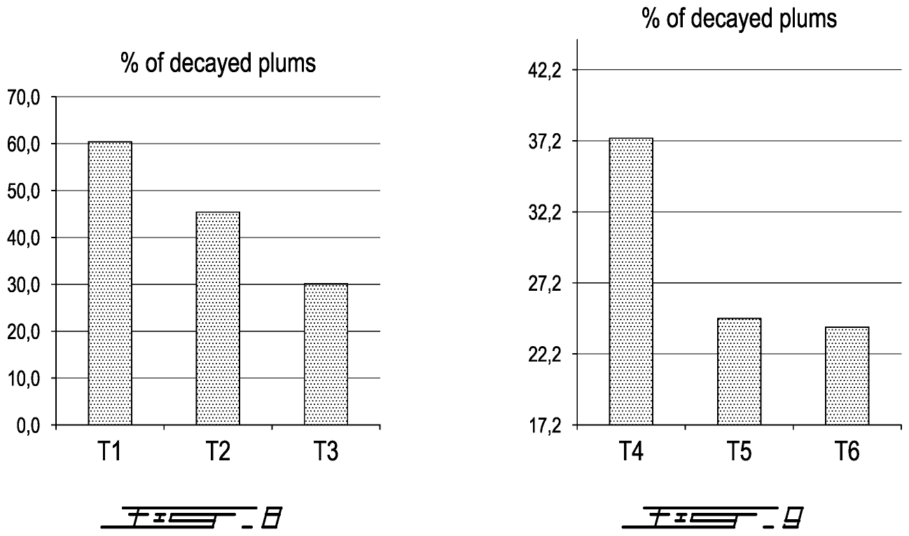

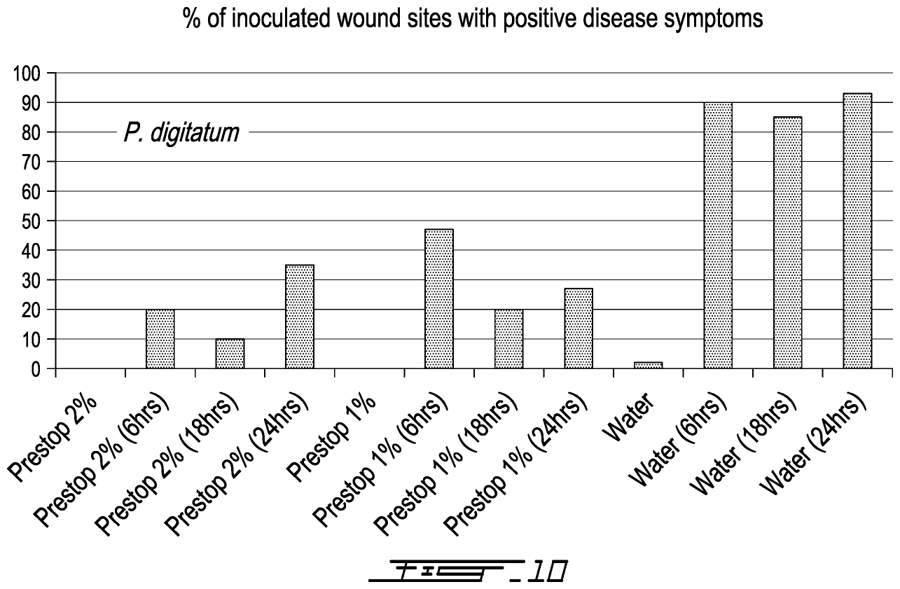

The results shown in FIGS. 8 and 9 clearly demonstrated that C. rosea f. catenulata J1446 protected the harvested plums against decay caused by pathogenic fungi as, for example, decay caused by Monilinia spp.

### Example 4: Effect of C. Rosea F. Catenulata Strain J1446 on Post-Harvest Decay Pathogens Penicillium Digitatum and Penicillium Italicum on Citrus Fruit

The objective of the study was to evaluate the effect of C. rosea f. catenulata strain J1446 on post-harvest decay pathogens P. digitatum and P. italicum on mandarins which are highly susceptible to Penicillium spp.

The test was carried out on healthy mandarins which were cleaned with water and left to dry. The fruits were injured with two perforations per mandarins.

The two fungic species tested were P. digitatum and P. italicum, and titration of the suspensions of spores of same was carried out using young 5-7 day cultures implanted in PDA medium (potato, dextrose and agar) and incubated at temperature of 24° C., by scraping of the colonies into sterile distilled water. A spore count was then carried out, setting the desired concentration, expressed in cfu/ml.

Batches of mandarins prepared as explained above were inoculated with the suspension of Prestop at a concentration of 1% and 2%. Six, 18 and 24 hours after the inoculation with C. rosea f. catenulata strain J1446 (Prestop), the fruits were inoculated with the titrated suspensions of pathogens of the two species selected, at concentrations of 10⁵ cfu/ml. In parallel to this the control test was set up, in which mandarins were inoculated only with the titrated suspension of the pathogen and sterile distilled water.

All the treated fruits were left to dry and placed in plastic bags to create high humidity. They were incubated at ambient temperature 20° C. for 3-4 days. The incubation period was set on the basis of the time needed for the control mandarins to present large rotting diameters. Following said incubation period the results were read, by evaluating the decay incidence (in percentage), by measuring the diameters of rot of all the perforations made and by examining the presence/absence of sporulation.

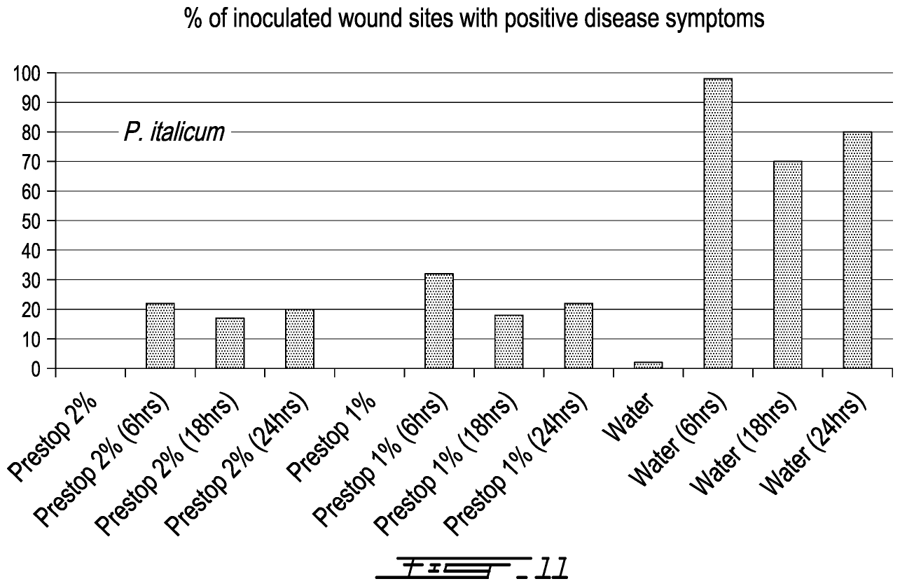

FIG. 10 shows the results obtained in the case of biological control of P. digitatum and FIG. 11 the results with P. italicum.

The results shown in FIGS. 10 and 11 demonstrated the high effectiveness of the antagonist C. rosea f. catenulata strain J1446 in control of the two species of pathogenic fungi tested and, consequently, in control of rotting of the fruits.

Following are particular embodiments of the disclosed invention.

E1. A post-harvest treatment method to protect harvested produce against plant pathogens, to prevent or reduce post-harvest microbial spoilage of harvested produce caused by plant pathogens and/or to control plant pathogens in harvested produce comprising applying to the harvested produce an effective amount of a culture of Clonostachys rosea.

E2. The post-harvest treatment method of E1, wherein C. rosea is C. rosea f. catenulata.

E3. The post-harvest treatment method of E2, wherein C. rosea f. catenulata is C. rosea f. catenulata J1446.

E4. The post-harvest treatment method of any one of E1 to E3, wherein the harvested produce is a fruit or a vegetable.

E5. The post-harvest treatment method of E4, wherein the fruit is a stone fruit.

E6. The post-harvest treatment method of E5, wherein the stone fruit is a peach, a nectarine, a plum, an apricot or a cherry.

E7. The post-harvest treatment method of any one of E1 to E6, wherein the plant pathogens are fungal plant pathogens.

E8. The post-harvest treatment method of any one of E1 to E7, wherein the plant pathogens are Penicllium spp., Alternaria spp., Rhizopus spp., Botrytis spp. or Monilia spp.

E9. The post-harvest treatment method of any one of E1 to E8, wherein said culture of C. rosea is combined with an agriculturally acceptable carrier.

E10. The post-harvest treatment method of any one of E1 to E9, wherein said culture of C. rosea is at a concentration of between about 10³ to 10¹² cfu/ml, about 10⁴ to 10¹¹ cfu/ml, about 10⁵ to 10¹⁰ cfu/ml or about 10⁶ to 10⁹ cfu/ml.

E11. The post-harvest treatment method of any one of E1 to E9, wherein said culture of C. rosea is in a dry formulation at a concentration of between about 10³ to 10¹² cfu/g, about 10⁴ to 10¹¹ cfu/g, about 10⁵ to 10¹⁰ cfu/g or about 10⁶ to 10⁹ cfu/g.

E12. Use of C. rosea to extend the post-harvest shelf-life of stored harvested produce.

E13. The use of E12, wherein C. rosea is C. rosea f. catenulata.

E14. The use of E13, wherein C. rosea f. catenulata is C. rosea f. catenulata J1446.

While the invention has been described in connection with specific embodiments thereof, it will be understood that it is capable of further modifications and this application is intended to cover any variations, uses, or adaptations of the invention following, in general, the principles of the invention and including such departures from the present disclosure that come within known or customary practice within the art to which the invention pertains and as may be applied to the essential features hereinbefore set forth, and as follows in the scope of the appended claims.

### REFERENCE

Wilson, C. L., Wisniewski, M., 1989. Biological control of postharvest diseases of fruits and vegetables: an emerging technology. Annu. Rev. Phytopathol. 27, 425-441.

1. A post-harvest treatment method for protecting harvested produce against post-harvest decay caused by plant pathogen, for preventing or reducing post-harvest decay of harvested produce caused by plant pathogen or for controlling plant pathogen on harvested produce comprising applying to the harvested produce an isolated culture, fungal spore or formulation of Clonostachys rosea in an amount effective to protect the harvested produce against post-harvest decay caused by plant pathogen, to reduce post-harvest decay caused by plant pathogen or to extend post-harvest shelf-life of stored harvested produce relative to an untreated control.

2. The post-harvest treatment method of claim 1, further comprising, after applying to the harvested produce the isolated culture, fungal spore or formulation of C. rosea, storing said harvested produce at ambient conditions of temperature.

3. The post-harvest treatment method of claim 1, further comprising, after applying to the harvested produce the isolated culture, fungal spore or formulation of C. rosea, storing said fruit at a temperature less than 5° C.

4. The post-harvest method of claim 3, further comprising, after storing said harvested produce at a temperature less than 5° C., storing said harvested produce at ambient conditions of temperature.

5. The post-harvest treatment method of claim 1, wherein C. rosea is C. rosea f. catenulata.

6. (canceled)

7. The post-harvest treatment method of claim 1, wherein the harvested produce is a fruit or a vegetable.

8. (canceled)

9. The post-harvest treatment method of claim 7, wherein the fruit is a stone fruit or a citrus fruit.

10. The post-harvest treatment method of claim 9, wherein the stone fruit is peaches, nectarines, plums, apricots or cherries.

11. The post-harvest treatment method of claim 9, wherein the citrus fruit is clementines, grapefruits, lemons, limes, mandarins, oranges or tangerines.

12. The post-harvest method of claim 1, wherein the post-harvest decay of harvested produce is caused by Penicillium spp., Alternaria spp., Rhizopus spp., Botrytis spp., Monilinia spp. or combinations thereof.

13. (canceled)

14. The post-harvest method of claim 12, wherein the post-harvest decay of stone fruit is caused by Monilinia spp.

15. The post-harvest method of claim 12, wherein the post-harvest decay of citrus fruit is caused by Penicillium spp.

16. The post-harvest method of claim 15, wherein the post-harvest decay of citrus fruit is caused by P. digitatum or P. italicum.

17. The post-harvest treatment method of claim 1, wherein said culture, fungal spore or formulation of C. rosea is combined with an agriculturally acceptable carrier.

18. The post-harvest treatment method of claim 1, wherein said culture of C. rosea is applied to the harvested produce at a concentration of between about 10³ to 10¹² cfu/ml, about 10⁴ to 10¹¹ cfu/ml, about 10⁵ to 10¹⁰ cfu/ml or about 10⁶ to 10⁹ cfu/ml.

19-43. (canceled)

44. A method for protecting harvested produce against post-harvest decay caused by plant pathogen, for reducing post-harvest decay caused by plant pathogen or for extending the post-harvest shelf-life of stored harvested produce relative to an untreated control, comprising applying an effective amount of an isolated culture, fungal spore or formulation of C. rosea.

45. The method of claim 44, wherein C. rosea is C. rosea f. catenulata.

46. (canceled)

47. The method of claim 44, wherein the harvested produce is a fruit.

48. (canceled)

49. The method of claim 47, wherein the stone fruit is peaches, nectarines, plums, apricots or cherries and the citrus fruit is clementines, grapefruits, lemons, limes, mandarins, oranges or tangerines.

50. (canceled)

51. The method of claim 44, wherein the post-harvest decay of harvested produce is caused by Penicillium spp., Alternaria spp., Rhizopus spp., Botrytis spp., Monilinia spp. or combinations thereof.

52-55. (canceled)
